(19) United States
(12) Patent Application Publication
(10) Pub. No.: US 2010/0115538 A1
(43) Pub. Date: May 6, 2010

(54) DISK LOADING MECHANISM

(75) Inventor: Norbert Kunze, Diez (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/525,097

(22) PCT Filed: Feb. 4, 2008
(86) PCT No.: PCT/IB08/50396

§ 371 Date: Jul. 30, 2009

(30) Foreign Application Priority Data
Feb. 8, 2007 (EP) 07101973.1

(51) Int. Cl. G11B 17/04

(52) U.S. Cl. 720/621; G9B/17.013

(57) ABSTRACT

A disk loading mechanism comprises a frame and a roller mounted on a carrier. The carrier is pivotable with respect to the frame to bias the roller onto the disk. It would be advantageous to provide a disk loading mechanism in which the forces exerted on a disk to be inserted in or ejected from a drive unit by a roller providing a movement of the disk are equal for the inserting and ejecting operations. To better address one or more of these concerns it is suggested to provide a disk loading mechanism comprising reduction gears which do not transmit any other than rotational forces onto the roller. Any other forces are accommodated for by the carrier and compensate each other such that they do not have any influence on the biasing of the carrier towards the disk.

### FIELD OF THE INVENTION

The invention relates to the field of disk loading mechanisms enabling the loading and unloading of a data medium, e.g. a compact disk, a digital video disk or a disk-shaped data medium in general, into or out of the drive unit of a play back module for a disk.

### BACKGROUND OF THE INVENTION

EP 1 396 861 A2 discloses a feed unit for a disk comprising a pair of bracket members axially spaced apart from each other securely mounted on the lower plate of a housing. The feed unit further comprises a supporting plate positioned between bracket members and pivotably supported by the bracket members and a rotation shaft supported by the supporting plate, with the center axis being in parallel relationship with the disk to be fed into the drive unit. The feed unit further comprises a pair of resilient members respectively constituted by coil springs resiliently urge the supporting plates towards the disk or its supporting surface to enable a disk to be held by the rotation shaft when a disk is loaded or unloaded into or from the drive unit, respectively. The feed unit further comprises driving means constituted by an electric motor and reduction gears. The first reduction gear is securely connected to the axial end of the rotation shaft so that the rotation shaft is driven by the electric motor through a second reduction gear, mounted on an axis perpendicular to the rotation shaft. The axis of rotation of the second reduction gear is formed by a shaft, pivotably mounted on the lower plate of the housing. Furthermore the second reduction gear is securely mounted at a fixed axial position on the shaft forming the second axis of rotation.

However, the feed unit exerts different forces via the rotation shaft onto the disk during operation depending on the direction of motion of the disk, i.e. different forces on a disk being inserted into or on a disk being ejected from the drive unit.

### SUMMARY OF THE INVENTION

It would be advantageous to provide a disk loading mechanism in which the forces exerted on a disk to be inserted in or ejected from a drive unit by a roller providing a movement of the disk are equal for the inserting and ejecting operations.

To better address one or more of these concerns, in a first aspect of the invention a disk loading mechanism is provided, comprising a frame and a carrier being movable with respect to the frame, a roller for frictional engagement with a disk, being rotatable around a first axis of rotation, wherein the roller is mounted on the carrier, a first gearwheel, being rotatable around the first axis of rotation, wherein the first gearwheel is mounted on the carrier, and wherein the roller and the first gearwheel are mechanically connected in order to provide a torque transmission from the first gearwheel to the roller, and a second gearwheel, being rotatable around a second axis of rotation, wherein the first axis of rotation and the second axis of rotation are perpendicular with respect to each other to provide a torque transmission from the second gearwheel via the first gearwheel to the roller, and wherein the second gearwheel is supported by the carrier in a direction parallel to the second axis of rotation.

In other words, the second gearwheel is supported such that any forces acting thereupon along the direction of its axis of rotation, for instance due to torque transmission from the first gearwheel, are accommodated for by the carrier supporting the second gearwheel.

The disk loading mechanism disclosed in the above reference can in principle be described with respect to the forces exerted on a disk inserted into or ejected from the drive unit by the drawing as depicted in FIG. 1. The roller 1 is driven by a first gearwheel 2 located on a first axis of rotation 3 of the roller 1. The first gearwheel 2 interacts with a second gearwheel 4, having a second axis of rotation 5 being perpendicular to the first axis of rotation 3. The shaft forming the first axis of rotation 3 is mounted on a carrier being pivotably mounted on the frame. The carrier 6 is biased by a spring 8 towards the surface 9 of the guide plate 7 of the frame. Therefore, when a disk 10 is inserted into the loading mechanism the disk 10 is pressed by the roller 1 onto the surface 9 of the guide plate 7. Due to friction between the disk 10 and the approximately flat surface 9 of the guide plate 7 and several not specified levers for controlling the loading mechanism a certain torque applied to the roller is necessary to rotate the roller and therefore to transport the disk in sliding movement over the surface 9. This torque is provided by the second gearwheel 4 via a force F in a direction parallel to its axis between the teeth of both gearwheels. This axial force F is equivalent to a radial force applied to the first gearwheel 2. The direction of the force F depends on the direction of rotation of the roller 1, i.e. inserting or ejecting of the disk 10. This axial force F changes its direction by 180° resulting in an increase or decrease of the force exerted by the roller 1 onto the disk 10. The difference of the resulting force between the inserting and the ejecting operation is the higher the higher the forces counteracting on a movement of the disk are.

This leads to an uncertainty in the transport of the disk in a first direction of movement, in the example shown during insertion of the disk and when the friction Fr and the lever forces are high. In this case the biasing force of the spring 8 is compensated to a certain extend by an upward force exerted on the first gearwheel. In an extreme situation the force decrease to a level where no transport of the disk 10 is possible anymore. Vice versa this possibly leads to a blocking of the loading mechanism in the other transport direction, in the present example when the disk is ejected from the unit and when the friction Fr and further lever forces are high. In this case the force transmitted to the first gearwheel adds to the force exerted onto the carrier 6 by the spring 8 and the force exerted onto the disk 10 is becoming increasingly high and a not shown driving-motor might block.

In contrast in a loading mechanism according to an embodiment of the present invention the force exerted from the roller onto the disk is independent of the direction of motion of the disk. It only depends on the biasing of the carrier towards the disk. Thus a closed loop of forces is formed within the carrier. The disk loading mechanism according to an embodiment of the invention comprises reduction gears which do not transmit any other than rotational forces onto the roller. Any other forces are accommodated by the carrier and compensate each other such that they do not have any influence on the biasing of the carrier and roller towards the disk.

Desirably in an embodiment of the invention the second axis of rotation is formed by a shaft being rotatably mounted on the frame and wherein the second gearwheel is movable with respect to the second axis of rotation in a direction parallel to the second axis of rotation. This way there is a torque transmission from the shaft forming the second axis of rotation onto the second gearwheel while simultaneously the second gearwheel can be supported or guided in an axial direction by the carrier which is movable with respect to the frame.

In terms of this application, a gearwheel shall mean any mechanical part of rotational symmetry enabling a torque transmission from a first onto a second axis of rotation. Thus, a gearwheel in this application can mean a toothed wheel, a friction wheel, a worm gear or any other torque transmission.

Even though the invention is termed a disk loading mechanism, disk loading in terms of the present invention also includes unloading of the disk from a respective drive mechanism, i.e. inserting and ejecting a disk.

Wherever a torque transmission from the second gearwheel to the roller via the first gearwheel is described, this could either mean a torque transmission by direct engagement between the first and the second gearwheels or there could be further gearwheels in engagement with each other provided in between the first and the second gearwheel such that there is a torque transmission chain between the second and the first gearwheel.

In a further embodiment of the invention the shaft forming the axis of rotation of the second gearwheel and the second gearwheel are in form-fit engagement with each other to provide a torque transmission from the shaft to the second gearwheel. In an embodiment this could be achieved by complimentary recesses and projections at the outer surface of the shaft and at a bore through the second gearwheel, respectively. This way, the torque transmission between the shaft and the gearwheel is provided while the gearwheel can still be moved in an axial direction parallel to and along the shaft and with respect to the frame on which the shaft is mounted.

Desirably there is an embodiment of the present invention providing a mechanical connection between the shaft and a third gearwheel. The third gearwheel might provide a mechanical connection to a drive, e.g. an electric motor.

According to an embodiment of the present invention, the carrier comprises a guide for the second gearwheel in a direction parallel to the second axis of rotation wherein the guide comprises a recess and wherein the second gearwheel comprises a circumferential rim extending into the recess. This way the movement of the second gearwheel in a direction parallel to the shaft forming the second axis of rotation is coupled to a movement of the carrier with respect to the frame. Of course, the guiding of the gearwheel by the carrier could be achieved by any other appropriate means, including a mechanical reversal, i.e. a rim associated with the carrier and a circumferential recess provided at the second gearwheel.

The different embodiments of the present invention are advantageously employed in a play back module for a data medium or a disk. A play back module in the sense of this application could be a simple play back module and/or a recording equipment, preferably for a compact disk or a digital video disk or any other disk-shaped data medium.

A play back module according to an embodiment of the present invention could be employed in a Hi-Fi system, advantageously in a portable or car Hi-Fi system.

These and other aspects of the invention will be apparent from and elucidated with reference to the embodiments described hereinafter.

### BRIEF DESCRIPTION OF THE ACCOMPANIED FIGURES

FIG. 1 schematically shows a disk loading mechanism according to the above reference.

FIG. 2 shows a three-dimensional side view of a disk loading mechanism according to above reference.

FIG. 3 schematically shows a disk loading mechanism according to an embodiment of the present invention.

FIG. 4 shows a three-dimensional side view of an embodiment according to the present invention with the second gearwheel in the lower position wherein the roller is in contact with the disk.

FIG. 5 shows a three-dimensional side view of an embodiment according to the present invention with the second gearwheel in the upper position wherein the roller is not in contact with the disk, i.e. in play position for the disk.

### DETAILED DESCRIPTION OF EMBODIMENTS

In the following description of the figures of embodiments according to the present invention the same or equal parts will be denoted by the same reference numbers in order to facilitate understanding. To denote alternative embodiments dashed reference numbers will be used.

FIG. 2 shows a three-dimensional side view of a disk loading mechanism according to the above reference. FIG. 2 gives an overall view of the disk loading mechanism, when a disk 10 is conveyed into or out of a drive unit for a disk play back module by a roller 1. As shown, the roller 1 comprises two conical sections such that the disk 10 and the roller 1 are only in mechanical engagement at the outer most edge of the circular disk 10. In order to provide a transport mechanism for the disk, the roller 1 is mounted on a carrier 6 being pivotable around pivot points 11. The disk 10 itself slides on the flat surface 9 of a guide plate 7 and is moved only by fictional engagement with the roller 1. In order to provide friction between the roller 1 and the disk 10, the carrier 6 is biased by a spring 8 such that its end carrying the roller 1 is pressed onto the disk 10 and towards the surface 9 of the guide plate 7. The first gearwheel 2 having a sloped tooth structure is connected to the roller 1 and rotatable around the same axis of rotation as the roller 1. The first gearwheel 2 provides a torque transmission from the first gearwheel 2 to the roller 1. In order to drive the first gearwheel 2 and the roller 1, respectively, a second gearwheel 4 having a sloped tooth structure is provided on an axis of rotation which is essentially perpendicular to the axis of rotation of the first gearwheel 2. The axis of rotation of the second gearwheel 4 is formed by a shaft 5 being mounted on the frame 12 of the disk loading mechanism. The second gearwheel 4 is directly connected to a third gearwheel 13 on the same shaft 5, providing a connection to an active drive, i.e. an electric motor.

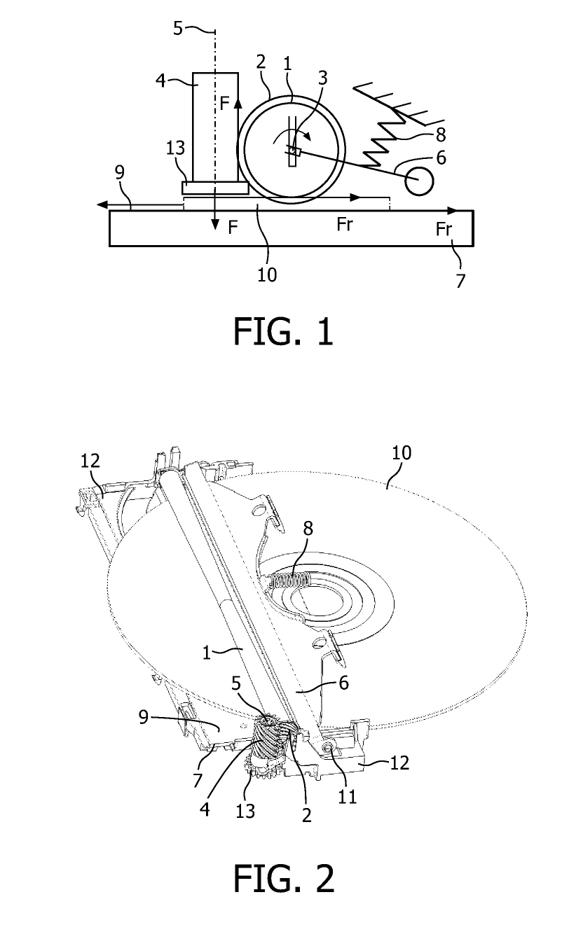

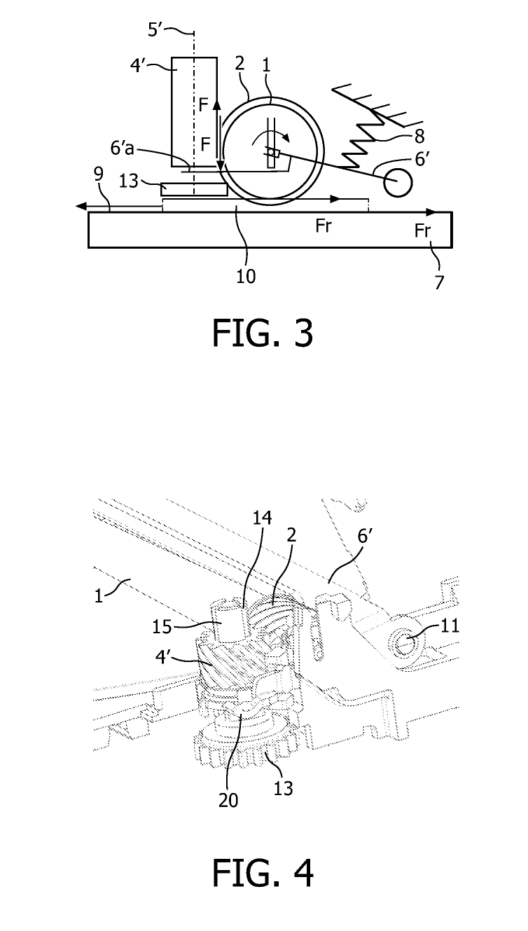

FIG. 3 shows a schematic side view of an improved loading mechanism according to an embodiment of the present invention. With respect to FIG. 1, the loading mechanism according to an embodiment of the present invention is modified with respect to the carrier 6′ as well as the second gearwheel 4′. The second gearwheel 4′ is still rotatable around an axis of rotation 5′. It is mounted on a shaft such that a torque transmission from a third gearwheel 13 onto the second gearwheel 4′ is provided. However, the second gearwheel 4′ is movable along the axis of rotation 5′.

The carrier 6′ therefore provides a guiding section 6′a in order to support and guide the second gearwheel 4′ in a direction parallel to the axis of rotation 5′. Thus, any forces transferred from the roller 1 via the first gearwheel 2 onto the second gearwheel 4′ are received by the carrier 6′ and thus do not have an influence on the force or pressure exerted by the roller 1 onto the disk 10. Thus, the force by which the disk 10 is pressed onto the surface 9 of the guide plate 7 is only determined by the spring 8 biasing the carrier 6′ in a direction towards the surface 9 of the guide plate 7.

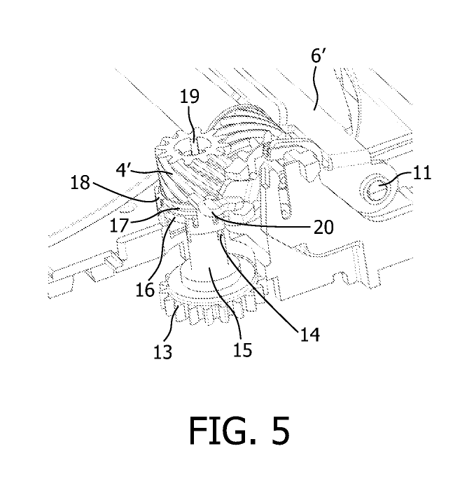

FIGS. 4 and 5 show three-dimensional sectional side views of an embodiment according to the present invention, depicting the axial movement of the second gearwheel 4′. The entire loading mechanism looks as depicted in FIG. 2, except for the changes to the gearwheels and the carrier.

As shown in FIGS. 4 and 5, the second gearwheel 4′ is movable in a direction parallel to the axis of rotation 5 on a shaft 15 which is coupled to a third gearwheel 13. In order to provide a torque transmission from the third gearwheel 13 via the shaft 15 onto the second gearwheel 4′, the shaft 15 comprises three recesses 14, extending in a direction parallel to the axis of rotation. The second gearwheel 4′ itself has a through hole in its center, providing three radial projections 19 which extending into the corresponding recesses 14 in the shaft 15. This arrangement provides a form-fit engagement between the second gearwheel 4′ and the shaft concerning a rotational movement, i.e. a torque transmission form the shaft 15 onto the second gearwheel 4′. Simultaneously the gearwheel 4′ remains movable in an axial direction.

All forces working on the second gearwheel 4′ in a direction parallel to the axis of rotation are accommodated by a supporting element 16. The supporting element 16 is in pivotable connection with the second gearwheel 4′ such that the second gearwheel 4′ as well as the shaft 15 are rotatable with respect to the supporting element 16. A connecting-contour 20 mounted to the carrier 6 interacts with the supporting element 16 and moves the assembly consisting of the second gearwheel 4′ and supporting element 16 with respect to the shaft 15 when the carrier 6 is pivoted around point 11. To enable a safe guiding of the second gearwheel 4′, the gearwheel itself comprises a circular rim 17 at its lower end in which snapfits 18 of the supporting element 16 slide during rotation of the second gearwheel. While FIG. 4 shows the second gearwheel 4′ in its lower position, FIG. 5 shows how upon pivoting the carrier 6′ together with the supporting element 16 moves the second gearwheel 4′ into its upper position. Any forces exerted on the second gearwheel 4′ in a direction parallel to the axis of rotation or to the shaft 15 are accommodated by the carrier 6′ via the supporting element 16.

This way, any axial forces applied to the second gearwheel can compensate the radial force applied to the first gearwheel in both transport directions of the disk at the same time. Thus the principle of forces applied to the roller mechanism is that of a closed loop of forces within the carrier.

While the invention has been illustrated and described in detail in the drawings and foregoing description, such illustration and description are to be considered illustrative and exemplary and not restrictive; the invention is not limited to the disclosed embodiments.

Other variations to the disclosed embodiments can be understood and effected by those skilled in the art in practicing the claimed invention, from a study of the drawings, the disclosure and the appended claims. In the claims the word “comprising” does not exclude other elements or steps, and the indefinite article “a” or “an” does not exclude a plurality. The mere fact that certain measures are recited in mutually different dependent claims does not indicate that the combination of these measures can not be used to advantage. Any reference signs in the claims should not be construed as limiting the scope.

### REFERENCE NUMBERS

1 roller
2 first gearwheel
3 first axis of rotation
4, 4′ second gearwheel
5, 5′ second axis of rotation
6, 6′ carrier
7 guide plate
8 spring
9 supporting surface
10 disk
11 pivot point
12 frame
13 third gearwheel
14 recess
15 shaft
16 supporting element
17 rim
18 recess
19 projection
20 connecting-contour

1. Disk loading mechanism comprising
a frame (12),
a carrier (6′) being movable with respect to said frame (12),
a roller (1) for frictional engagement with a disk (10), being rotatable around a first axis of rotation (3), wherein said roller (1) is mounted on said carrier (6′),
a first gearwheel (2), being rotatable around said first axis of rotation (3), wherein said first gearwheel (2) is mounted on said carrier (6′), and wherein said roller (1) and said first gearwheel (2) are mechanically connected in order to provide a torque transmission from said first gearwheel (2) to said roller (1), and
a second gearwheel (4′), being rotatable around a second axis of rotation (5′), wherein said first axis of rotation (2) and said second axis of rotation (5′) are perpendicular with respect to each other to provide a torque transmission from said second gearwheel (4′) via said first gearwheel (2) to said roller (1),
and wherein said second gearwheel (4′) is supported by said carrier (6′) in a direction parallel to said second axis of rotation (5′).

2. Disk loading mechanism according to claim 1, wherein said second axis of rotation (5′) is formed by a shaft (15) being rotatably mounted on said frame (12), and wherein said second gearwheel (4′) is movable with respect to said second axis of rotation (5′) in a direction parallel to said second axis of rotation (5′).

3. Disk loading mechanism according to claim 2, wherein said shaft (15) and said second gearwheel (4′) are in form-fit engagement with each other to provide a torque transmission from said shaft (15) to said second gearwheel (4′).

4. Disk loading mechanism according to claim 3, wherein said shaft (15) is connected to a third gearwheel (13).

5. Disk loading mechanism according to claim 1, wherein said carrier (6′) comprises a guide (6′a) for said second gearwheel (4′) in a direction parallel to said second axis of rotation (5′), wherein said guide (6′a, 16) and said second gearwheel (4′) comprise means for guiding said second gearwheel (4′) in an axial direction.

6. Disk loading mechanism according to claim 5, wherein said means for guiding are formed by a supporting element (16) which is pivotably connected to said second gearwheel (4′) and a connecting-contour (20) mounted on said guide (6′ a), wherein said connecting-contour (20) is in connection with said supporting element (16) in order to move said second gearwheel (4′) in a direction parallel to said second axis of rotation (5′) when said carrier (6′, 6′a) is moved with respect to said frame (12).

7. Play back module for a disk comprising a disk loading mechanism according to claim 1.

8. Hi-Fi system comprising a play back module according to claim 7.
